(19) United States
(12) Patent Application Publication
(10) Pub. No.: US 2023/0249821 A1
(43) Pub. Date: Aug. 10, 2023

(54) Reflective Hollow SRM Material and Methods

(71) Applicant: Sinapu LLC, Monrovia, CA (US)

(72) Inventor: Peter Butzloff, Walnut, CA (US)

(21) Appl. No.: 18/126,440

(22) Filed: Mar. 26, 2023

Related U.S. Application Data
(63) Continuation-in-part of application No. PCT/US2021/057343, filed on Oct. 29, 2021.
(60) Provisional application No. 63/107,450, filed on Oct. 30, 2020.

(51) Int. Cl. B64D 1/08; B64D 1/16; A01G 15/00

(52) U.S. Cl. CPC B64D 1/08; A01G 15/00; B64D 1/16

(57) ABSTRACT

Methods of geoengineering are provided to create shade by reflecting solar radiation into space to mitigate global warming, as well as reduce storm severity, and other applications. These methods rely on dispersing hollow silicate microspheres into the atmosphere, or into orbit, by aircraft or rocket, where the silicate microspheres can optionally comprise additions of one of boron or sodium, or both. Silicate microspheres manufactured on the Moon can be delivered to Earth or L1 orbit as an alternative to lofting from Earth’s surface. Hollow silicate microspheres are more than 6 times the size of comparable solid SRM particles. This method substantially improves reflectivity, solar-powered lofting, and, in the presence of liquid water aerosols, the greater surface area enables improved carbon dioxide capture.

### CROSS-REFERENCE TO RELATED APPLICATIONS

This application is a Continuation-in-Part of International Application PCT/US21/57343 filed on Oct. 29, 2021 entitled “REFLECTIVE HOLLOW SRM MATERIAL AND METHODS” which claims benefit and priority to U.S. provisional patent application 63/107,450 filed on Oct. 30, 2020 and entitled “REFLECTIVE HOLLOW BOROSILICATES AND TERRAFORMING METHODS” both of which are incorporated herein by reference in their entireties.

### BACKGROUND

### 1. Field of Invention

The present invention provides a reflective composition of matter used to perform elevated solar radiation management (SRM) to reduce surface planetary temperatures (global cooling) by dispersing hollow silicate particles into the first Lagrange point L1 or planetary orbit or into the upper regions of the planetary atmosphere, and a method to maximize the effective residence time of a deployed SRM material.

### 2. Background Art

The concept of airborne dust injected into the uppermost layers of the Earth’s stratosphere is well documented as a function of natural volcanic eruptions. Radioactive dust injections have also been explored and later outlawed in the context of government sponsored testing of open-air nuclear fission and fusion bomb explosions. Highly reflective aerosols in the form of lofted particles have been studied to manage solar radiation for the purpose of cooling the Earth. Disadvantages of the deliberate injection of highly reflective sulfurous compounds for solar radiation management (SRM) include the eventual chemical formation of sulfuric acid, which can add to ocean acidification with that of carbonic acid from dissolved carbon dioxide. Presently there is already widespread evidence of coral bleaching with the shift to hypoxic and acidic conditions associated with corrosive toxicity; these acidification effects can eventually extend to cause significant harm to the chitin of essential fish, shrimp, and insect pollinators. The potential frightening consequences of poorly researched ancillary effects arising from some of the SRM materials have moved some public opinion away from considering the use of, for example, sulfur or sulfate types of SRM compositions.

Another such SRM candidate is calcium carbonate. Though reasonable reflective, and not being of an acidic nature, the carbonates have been found wanting as SRM particles because of their high density and subsequent short atmospheric residence times in air. Even when considered in an orbital deployment context, the cost associated with lofting heavy carbonates to orbit is prohibitive.

The concept of “specific reflectivity” or “specific reflectance” is used herein for SRM compositions and is defined as the average particle reflectivity divided by the density of the particle. Assuming a density of calcium carbonate of 2.711 kg/m³ and an average particle reflectivity of 86% provides a specific reflectivity of 0.86/2.711 or 0.317 as a figure of merit for density corrected solar reflectivity for these particles in high altitude SRM lofting purposes. Sulfur dust, often used as an infra-red reflectivity standard, is about 93% reflective at an average particle density of 1.98 kg/m³ and provides a specific reflectivity of 0.93/1.98 or a specific reflectivity of 0.474, only slightly greater in terms of specific reflectivity. The specific reflectivity can be an estimate of the weight cost of deployment at altitude, however it can also serve as an indirect guide for how long a stratospheric or upper tropospheric particle may reside in the air. Wind speed, air pressure, and molecular mean free path are additional variables acting on SRM particles to be considered in atmospheric SRM models. It is logical that denser particles will tend to drop out of the atmosphere sooner when their density is substantially greater than the density of the air at the level of their deployment. Average windspeed plays a role in estimating SRM atmospheric residence time. Verified measures for the SRM particle partition coefficients are needed to confirm the effects of particle density, lift, and atmospheric residence time in existing climate models.

The ability to restore or at least to recover some of the lost fecundity of oceans, as well as to recover land crop growing regions damaged by fire, drought, and floods is the goal of SRM. Some type of global cooling is required to counteract the undesirable meteorological effects of global warming induced by the heat retention of greenhouse gases. It is therefore essential to consider various artificial means of mitigating the worst outcomes of our artificially created and unavoidably shared global climate disaster.

The design of shades for the Earth has often been a subject for aerospace engineers and even some forward-looking meteorologists. These thermal management considerations often take priority over the matter of what to do with the excess carbon dioxide (CO₂). Carbon dioxide is dangerous not only because of its greenhouse gas warming effect, but because of harmful acidification of bodies of water. Acidic conditions can promote toxic kinds of viruses, bacteria, funguses, and algae blooms at the surface of the oceans as well as on land.

Consideration of geoengineering projects, such as sulfur-based dust injection into the upper atmosphere, Fresnel lenses placed in outer space at an orbit at the L1 position, and calcium carbonate dust injections have been proposed and debated for many years. These projects, when implemented as stand-alone solutions with no end-of-product service continuation, or having serious other damaging consequences, are not now and may never become technically or economically feasible. The purpose of the present invention is to provide practical alternative methods to address these deficits.

### SUMMARY OF THE INVENTION

These and other advantages of the present invention will be further understood and appreciated by those skilled in the art by reference to the following written specification, claims, and appended drawings.

Some embodiments are described in detail with reference to the related drawings. Additional embodiments, features, and/or advantages will become apparent from the ensuing description or may be learned by practicing the invention. In the illustrations, which are not drawn to scale, like numerals refer to like features throughout the description. The following description is not to be taken in a limiting sense but is made merely for describing the general principles of the invention.

The present invention provides methods of using a low density and high specific reflectance composition for modifying planetary irradiance for long-term global cooling when deployed at high atmospheric elevations or in planetary orbit.

The performance rating of exemplary commercial compositions to be utilized in accordance with the present specification is tabulated by specific reflectance as follows:

| SiO₂, a Hollow Sand Substance, Engineered Glass Microspheres, Commercial Brand | Specific Reflectance | Commercial Vendor |
|---|---|---|
| ‘K-20’ type | 4.30 | 3 M ‘Glass Bubbles’ 3 M Advanced Materials Division 3 M Center St. Paul, MN 55144, USA |
| ‘Q-Cel® 300’ type | 4.01 | Potters Industries 600 Industrial Rd. Carlstadt, NJ 07072 |

Earth receives approximately 176,000 terra-watts of power from the sun. If a small fraction of this power, for example, about 1% were blocked or reflected away, this would result in a significant countering of the global temperature rise. Deployment of this invention involves the placement of reflective particles to manage solar radiation over many millions of square kilometers into high altitude (stratospheric) or low Earth orbit, or both. A Low Earth Orbit (hereinafter LEO) is an orbit around earth with an altitude above Earth’s surface between 250 kilometers and 2,000 kilometers (1,200 miles) and an orbital period between about 80 and 130 minutes. Embodiments of the present invention also deploy reflective particles at lower levels of the atmosphere to reduce the energy available to cyclonic storms, and methods to sequester carbon dioxide.

The primary aspect of the present invention advances the science and technology of global cooling by high altitude redirection of solar irradiance before the lower atmosphere or the surface of the Earth can become heated. This is achieved by using inexpensive hollow borosilicate glass microspheres.

In another aspect, the hollow microspheres are as much as six times larger than the most common 11-to-14-micron solid particles residing for long times in the atmosphere. This size increase is possible because the microsphere is both hollow and more buoyant than solid SRM particulates.

In another aspect, solar powered lofting ability is conferred to the hollow glass microspheres by the action of lift energy arising from a dark coated region on the microsphere while being irradiated during daylight hours.

In another aspect, the presence of greater than 16 percent sodium by weight in the glass microspheres enables the microspheres to dissolve with continued exposure to liquid water, such as in clouds where water will condense onto the glass microspheres. In this way, the microspheres can be naturally removed from the atmosphere over time. As such their deployment in tropospheric clouds, especially for marine cloud brightening (MCB), will reduce the effective radius of the cloud water droplets over open ocean where sea ice does not exist.

In a related aspect, the sodium in the glass can react with carbon dioxide (CO₂) in the air directly on the surface of the glass microsphere to form crystals of sodium bicarbonate. This acts to sequester CO₂ in a compound with a high density of 2.54 Kg/m³ that will fall out of the atmosphere, where much of it can eventually settle to the bottom of the sea, assuming the oceanic pH is still sufficiently caustic.

In another aspect of the present invention, air is entrapped within silicon dioxide glass microspheres to help confer temperature equilibration and thermal stress management capability to the surface of the glass microsphere.

In a related aspect, a sharp discontinuity in the refractive index of silicate glass in the buoyant round glass particles is achieved at the internal glass to air interface. The high radius of curvature within this type of particle is on the order of the wavelength of incident light, which has a maximum irradiance at a wavelength of about 550 nanometers or 0.55 microns. This allows significant reflection of incident light even at zero degrees of incidence from vertical rays of sunlight, because a significant quantity of incident light will enter this interface at a high grazing angle to the internal void bubble entrapped within this structure. This material has about 86% reflectivity before any optional materials are added to modulate reflectivity.

In a related aspect, the interiors of the spherical silicate glass particles have a reduced pressure relative to standard atmospheric pressure (1 atm) to confer structural stability when deployed in a vacuum or in a reduced atmospheric pressure environment.

In another aspect, orbital or atmospheric deployment over equatorial regions of a planet will be most helpful to reflect solar irradiance, leading to significantly reduced temperatures at low latitudes of the surface.

In other aspects, the deployment of the SRM particles can be into dangerous orbital pathways such as regions of high radiation known as the Van Allen Belts, to visibly demark these orbits and to discourage entry into these orbital pathways for the safety of manned and unmanned spacecraft.

### BRIEF DESCRIPTION OF THE DRAWINGS

Preferred embodiments of the invention will now be described, by way of example, with reference to the accompanying drawings, in which:

FIG. 1 illustrates reflective hollow borosilicate glass microspheres, according to the teachings of the present invention.

FIG. 2 illustrates a release vessel for the dispersion and lofted release of reflective hollow borosilicate glass microspheres.

FIG. 3 illustrates various types of cargo delivery vessels to transport a cargo of reflective hollow borosilicate glass microspheres into the earth’s upper atmosphere or into low earth orbit (LEO).

FIG. 4 illustrates solar energy flux from the sun to the earth, and a result of reflective shading from lofted atmospheric or orbitally deployed reflective borosilicate glass microspheres.

FIG. 5 illustrates the manufacture and launch of reflective hollow borosilicate glass microspheres from the Moon to desired orbits around the Earth or elsewhere between the sun and the Earth for optical occlusion.

FIG. 6 illustrates the distribution of average solar energy as a function of latitude versus a reduced solar energy distribution.

FIG. 7 illustrates the reflectivity properties of various materials compared with the reflectivity of hollow borosilicate glass microspheres.

FIG. 8 is a flowchart representation of a method to perform lofted solar radiation management by use of reflective hollow borosilicate glass microspheres.

FIG. 9 illustrates an exemplary coating process and an exemplary coated microsphere made thereby.

FIG. 10 is a flowchart representation of another exemplary method of the present invention.

Some embodiments are described in detail with reference to the related drawings. Additional embodiments, features, and/or advantages will become apparent from the ensuing description or may be learned by practicing the invention. In the illustrations, which are not drawn to scale, like numerals refer to like features throughout the description. The following description is not to be taken in a limiting sense but is made merely for describing the general principles of the invention.

### DETAILED DESCRIPTION OF THE INVENTION

The following detailed description, taken in conjunction with the accompanying drawings, is merely exemplary in nature and is not intended to limit the described embodiments or the application and uses of the described embodiments. Any implementation described herein as “exemplary” or “illustrative” is not necessarily to be construed as preferred or advantageous over other implementations.

Furthermore, there is no intention to be bound by any expressed or implied theory presented in the preceding technical field, background, brief summary or the following detailed description. It is also understood that the specific devices, systems, methods, and processes illustrated in the attached drawings, and described in the following specification, are simply exemplary embodiments of the inventive concepts defined in the appended claims that there may be variations to the drawings, steps, methods, or processes, depicted therein without departing from the spirit of the invention. All these variations are within the scope of the present invention. Hence, specific structural and functional details disclosed in relation to the exemplary embodiments described herein are not to be interpreted as limiting, but merely as a representative basis for teaching one skilled in the art to variously employ the present embodiments in virtually any appropriate form, and it will be apparent to those skilled in the art that the present invention may be practiced without these specific details.

Various terms used in the following detailed description are provided and included for giving a perspective understanding of the function, operation, and use of the present invention, and such terms are not intended to limit the embodiments, scope, claims, or use of the present invention.

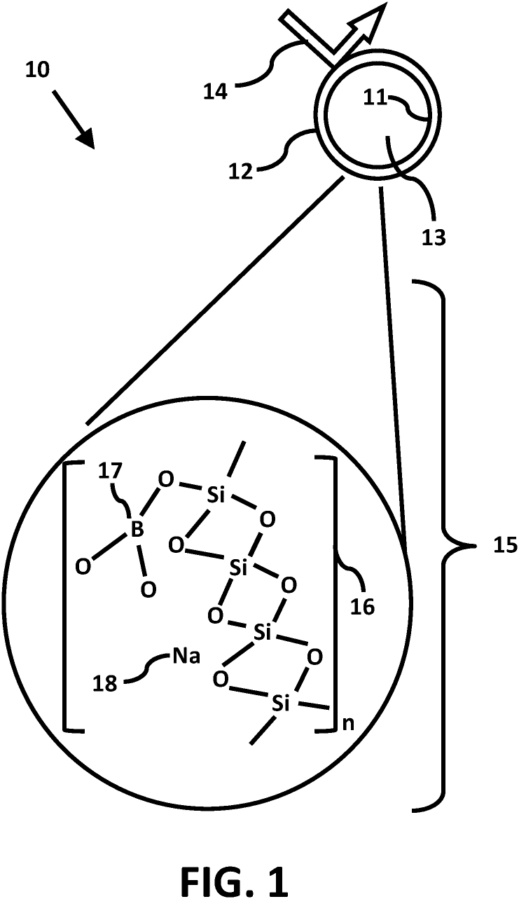

FIG. 1 illustrates the physical structure and molecular composition of a deployable hollow glass microsphere 10 comprising a generally spherical glass layer 12 surrounding a generally spherical internal hollow space 13 filled with air or another gas. The microsphere 10 includes an internal radius boundary 11, that is, an internal surface at which the discontinuity between the index of refraction of the glass and that of the air causes reflection of incident light rays 14. In various embodiments the particle size of the hollow microspheres 10 is greater than about 10 microns and less than or equal to about 100 microns, which is profoundly greater than the median average long term aerosol particle size of 14 microns, because this uniquely provides an expanded surface area for reflectivity by means of having a low density and a calculated specific reflectivity greater than about 3.5. While there is no theoretical size too small, the practicality of manufacturing indicates a lack of a significant inside diameter bubble in commercial materials with a diameter less than about 10 microns. Thus, smaller particles tend to produce solid glass with a high density that has poor buoyancy and a low residence time in air. The concept of a specific reflectance helps to show this important property of enhanced reflectivity and low-density enabled extended service life at altitude. The specific reflectance provides a crude but useful static factor that can help to rank approximate residence lifetimes at altitude to help governments and ecological remediation organizations reach consensus and then select among our best economically competitive reflective SRM particles. The glass composition is to have no sodium (Na) content when the intent is to maximize the tropospheric SRM lofted lifetime for reflectivity purposes, because sodium promotes glass corrosion in the presence of liquid water. No sodium content in the microsphere thus avoids glass corrosion on exposure to liquid water droplets except when precipitated into the ocean, which is alkaline at pH 8.1. In applications having no boron and a sodium (Na) content of at least 20% by weight for lofted deployment at average cloud elevations at or below about 5000 meters altitude, a function is provided for marine cloud brightening (MCB) to sequester carbon dioxide (CO₂) by the formation of sodium bicarbonate. It is understood that other coating materials may be applied to the microspheres and may be used to react with atmospheric CO₂ in the presence of liquid water in like manner. The hollow glass microspheres method provides SRM of greater than six times the size of all known solid SRM particles (presently averaging about 14 microns) by use of a hollow core space or void 13, to uniquely address the present lack of enhanced specific reflectivity by providing a greater surface area, which then permits significant chemical diffusion and carbon sequestration functions to be performed at altitude where these processes are more effective at preventing the heating of the atmosphere and planet below. The greater particle surface area and low particle density of hollow glass microspheres now enables engineers a powerful capability to promote multiple simultaneous SRM effects at altitude.

The dissolution rates for silicate glasses in seawater are temperature dependent and have been well characterized. All silicate glass compositions dissolve in seawater, as the ocean has a pH of 8.1. The caustic reaction with sodium in seawater will act to dissolve almost all silicate glass without boron within 1 month and within 5 months for borosilicate glass, since boron imparts some resistance to sodium corrosion in liquid water.

The glassy atomic structure of silicon dioxide is represented by the inset view 15. The silicate glass structure 16 has a multiplicity of silicon and oxygen bonds as denoted by the subscript (n). The silicate glass structure 16 has localized distortion of the bonds between the silicon (Si) and the oxygen (O) away from more regular lattice locations that are characteristic of amorphous silicon dioxide glass. The silicate glass structure 16 includes impurity metal cations such as sodium 18, represented by atomic symbol Na. Addition of sodium generates a soda glass that reacts with and then sequesters carbon dioxide (CO₂) from the atmosphere, or reacts with carbonic acid when moisture is present. Sodium addition greater than 20% will minimize the lifetime of the soda glass particle when in contact with the air to maximize the remediation of CO₂.

Borosilicate glass is an example of a suitable stable silicate glass for use in the high altitude where the boron is a glass corrosion inhibitor and will extend the lofted particle lifetime as a solar radiation reflector material or SRM. Borosilicate glass normally includes about 5% to about 13% boron trioxide (B₂O₃) by weight, where this impurity incorporation is indicated by the symbol B for boron 17. The corrosion rates for silicate glass, sodium silicate glass, and borosilicate glass in air are well known to be about 100 times less in humid air than on contact with liquid water. Glass corrosion may be desired when applied to clouds below the dew point temperature for carbon sequestration by sodium carbonate formation. However, it is to be understood that commonly, the term glass or the term silicate glass may be used to refer to all types of glass for the purpose of the present invention, regardless of the doping or impurity content. Commercial grades of borosilicate glass raw material have been well characterized and are able to be produced from well-known companies such as Pyrex, Duran, Potters Industries, and 3 M corporation. Borosilicate glasses have low coefficients of thermal expansion (CTE). Type 7740 Pyrex has a thermal expansion coefficient (CTE) of about one third that of a typical soda glass. Borosilicate glasses are, therefore, less subject to stress caused by thermal expansion and thus less vulnerable to cracking from thermal shock.

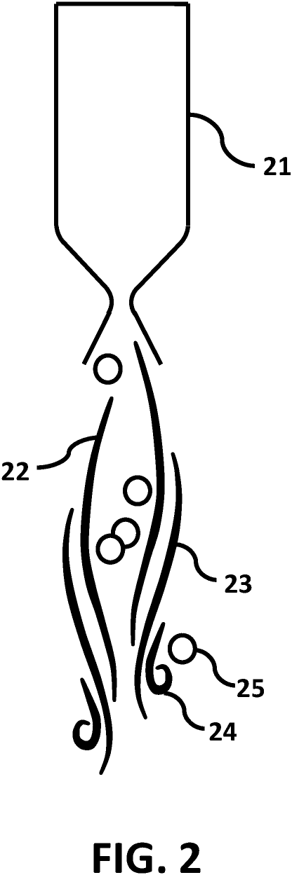

FIG. 2 illustrates a cross-sectional view of a containment vessel 21 with release of its contents of microspheres 25. The containment vessel 21 is designed to carry, for example, many billions of reflective borosilicate glass microspheres, represented here by just a few microspheres, shown as round microspheres 25. The microspheres, along with any optional applied electrostatic charge, or gaseous or liquid additives such as air, jet fuel, or rocket fuel provided as a dispersant, can be ejected along with the dispersant represented by curled streamer lines 22, 23, 24. The dispersant may be a liquid or a gas that is used to assist with the expulsion of contents of the vessel 21 into the correct altitude or orbit. Expulsion of contents can also be achieved by electrostatic repulsion by electrically charging the microspheres 25, where the vessel 21 becomes the conductive electrode. The use of electrostatic charges applied to the microspheres causes them to mutually repel one another after ejection. Containment vessel 21 may be composed of any material that is able to perform repeated service, such as metal alloys or composite materials.

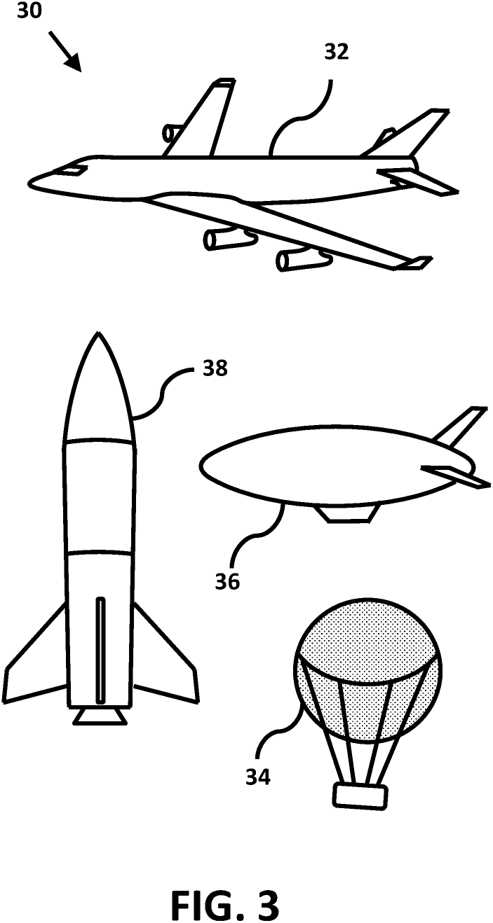

FIG. 3 illustrates exemplary transportation modes 30 that may be used to deploy the reflective hollow glass microspheres. Transportation modes 30 include those that remain in the atmosphere, collectively “aircraft” herein, and those that can enter Earth orbit. High altitude winged aircraft 32 may be used to deploy reflective glass microspheres by the timed release of such particles from multiple containment vessels such as the one illustrated in FIG. 2. It is notable that atmospheric dispersion by winged aircraft 32 can be directionally assisted by the exhaust stream from the engines of the aircraft 32. High altitude balloons 34 of the type often used for weather monitoring and the placement of scientific instruments may also be used to deploy reflective glass microspheres. In some embodiments, the rate of release of the glass microspheres can be adjusted so as to balance the gradual loss of buoyancy as the balloon 34 loses helium or hydrogen, analogous to ballast release to maintain constant altitude. Similarly, high altitude dirigibles 36 may also be used to deploy reflective glass microspheres while performing an otherwise unrelated transportation task, such as transporting people or cargo. Additionally, spacecraft 38 can be used for orbital placement of reflective glass microspheres. In some embodiments, this release of mass imparts a force upon the spacecraft 38 that can be used as part of an orbital maneuver, alone or in combination with other propulsion methods. It is understood that other shapes of carrier craft and a variety of launch or propulsion methods, including rockets, may be used to perform the delivery and deployment of the microspheres at atmospheric altitudes sufficiently beyond aviation elevations, or into orbits not used by orbital satellites.

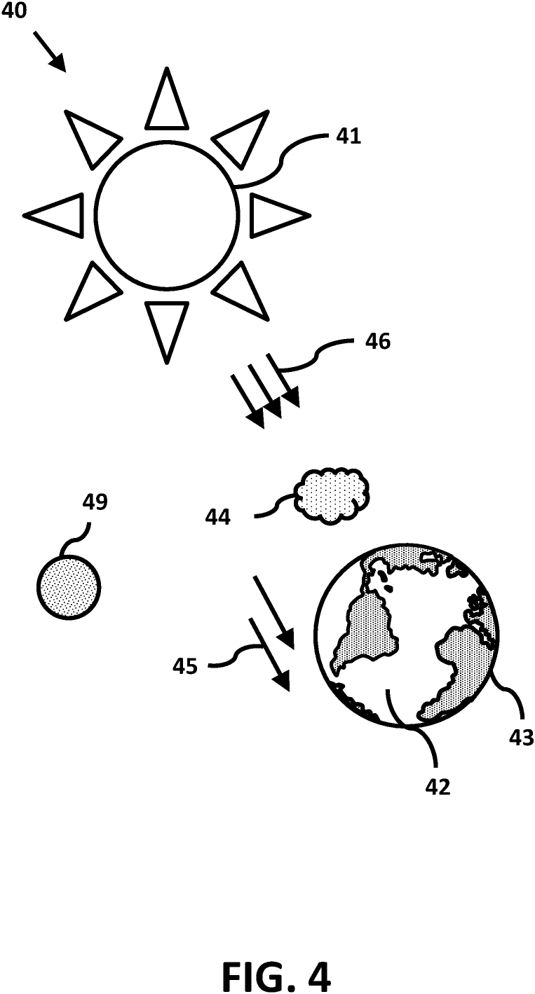

FIG. 4 illustrates how solar energy flux is differently distributed as a function of the angle of irradiance at the Earth’s surface 43. The sun 41 radiates with a maximum spectral output at about 550 nanometers, where the maximum energy density is of mostly visible light and arrives in greatest areal flux perpendicular to the low planetary latitudes as indicated by 46. Fewer rays per square meter arrive at the polar regions and strike the planet at high angles of incidence 45. The presence of the Earth’s Moon 49 is illustrated for the purpose of perspective. A deployed cloud 44 of reflective microspheres shows their elevated deployment in the upper atmosphere, or in orbit, at or near to the equator and the nearby low latitudes of the Earth to create a shield or shadow effect.

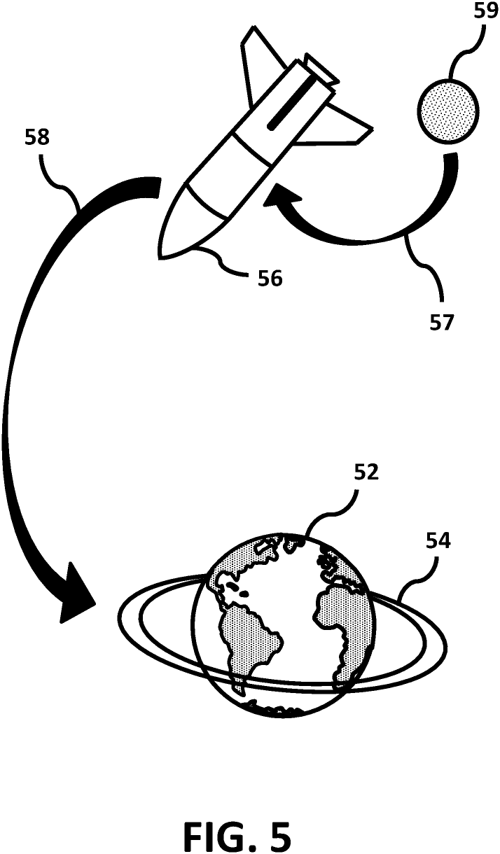

FIG. 5 illustrates an embodiment in which the glass microspheres 10 are manufactured on the Moon, transported back to Earth, and deployed directly into Earth orbit. Manufactured glass microspheres 10 placed in one or more containment vessels 21 depart the Moon 59 via rocket 56 in the direction of 57, 58. When deployed, the glass microspheres can form parallel arcs 54. It is understood that lunar manufacturing and delivery to Earth orbit can be more economically effective than lifting these materials from the surface of the Earth. Moreover, the same lunar manufacturing and delivery process can be used to terraform a planet different than Earth 52, such as for example, Venus.

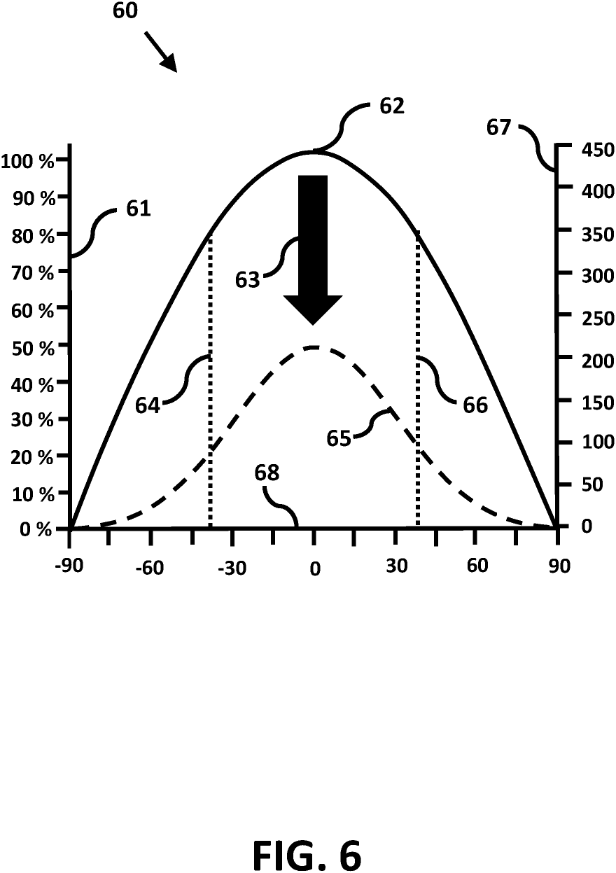

FIG. 6 illustrates a model comparison of the effective irradiance with and without a planetary reflectance shield in a dual y-axis graph 60. The scale of the X-axis 68 denotes the planetary latitude. The scale of the left Y-axis 61 denotes the percentage of the effective solar irradiance at the surface of the Earth or a similar planet. 62 is a curve representing the theoretical full incident solar irradiance flux to arrive at the surface of the earth as a function of latitude and scaled to 100 percent. The scale of the right Y-axis 67 denotes the power in watts per square centimeter of the effective solar irradiance at the surface of the Earth. The shielded solar irradiance result reaching the planetary surface at different latitudes is marked at the values of the dashed line 65. The desired true reflectance of the deployed glass microspheres 10 is desirably bound by the dotted vertical line 64 at about -40 degrees south latitude, and at the dotted vertical 66 line at about 40 degrees north latitude. Black arrow 63 shows the direction of decrease in the solar irradiance resulting from the optical occlusion and reflectance of the lofted SRM microsphere particles. The limits 64, 66 may be adjusted, however the intent is to not reduce the amount of solar irradiance at higher latitudes where light energy is already naturally reduced.

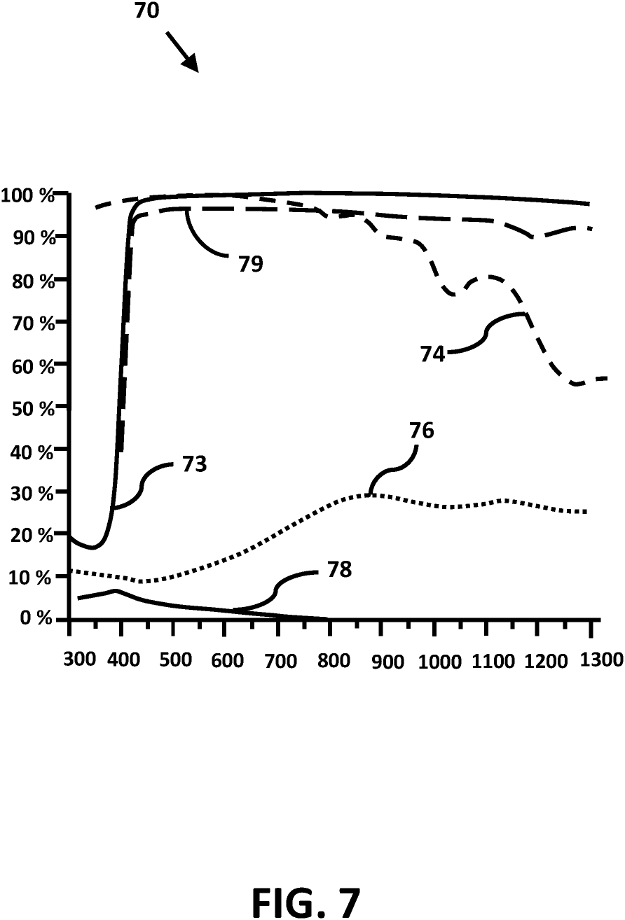

FIG. 7 illustrates experimental data in graph 70 showing the percentage (%) reflectance or albedo of several materials (y-axis) as a function of the wavelength (x-axis) of the reflected light, in nanometers, to compare reflectance characteristics as a function of wavelength. The most important region of this experimental data is at about 550 nanometers, where the solar irradiance achieves a maximum value. Dashed black line 74 with short dashes represents the reflectivity of snow. It is useful to note that the reflectivity of pure snow is 99 percent around the maximum solar output of about 550 nanometers. Very little of the solar irradiance at the surface of the earth arrives less than 400 nanometers of wavelength. This is useful to understand the experimental reflectance data of titanium dioxide (TiO₂) indicated at solid line 73 maintains 99 percent or greater reflectance well into the deep red and near infra-red wavelengths. Overall, titanium dioxide is more reflective than pure snow. Dotted line 76 represents the plot of reflectance of pure crystalline silicon dioxide sand, which is about 10 percent near the solar maximum output of 550 nanometers and drops to 8 percent or less reflectance depending on the amount of added moisture. It is notable that the data represented by line 76 is very different than the reflectance of hollow borosilicate glass spheres, represented by dashed line 79. Hollow borosilicate glass spheres reflect 86 percent of the incident solar radiation at the maximum solar output of 550 nanometers, thereby conferring only 13 percent less reflectance than water ice or titanium dioxide at significantly less weight for more economical lofting.

For comparison, the solid black line 78 represents the experimental reflectance data of liquid water at all angles of light incidence that are less than about 85 degrees. Pure liquid water is substantially absorbing solar radiations at most visible and infrared frequencies, having only a trace of reflectance being no greater than about 4 percent at the 550 \-nanometer solar maximum irradiance output. Pure crystalline silicate sand is shown by dotted line 76.

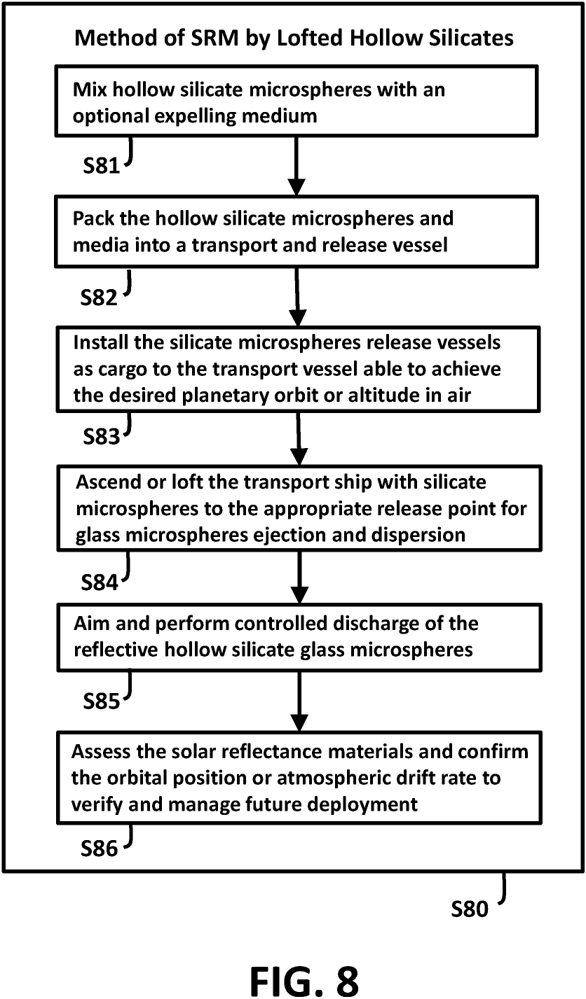

FIG. 8 provides a flowchart representation S80 of an exemplary method for terraforming or geoengineering a planet such as the Earth or Venus. It is to be understood that method S80 uses silicates mined from the Moon or asteroid belt to reduce the cost of delivery into LEO or low Venus orbit (LVO). In a step S81, a desired quantity of about 3% to 13% of boron trioxide containing silicate glass microspheres is mixed with an optional dispersion gas or volatile medium to help expel and place a spatial dispersion of this composition at altitude or in orbit. In step S82, the microspheres and optional dispersant into a transport vessel. In step S83, the microspheres are carried as cargo by the transport vessel to the desired planetary orbit or altitude. In step S84, the microspheres are brought to the appropriate release point in the orbit or into the atmosphere at the altitude for release and dispersion. In step S85, the microspheres are released from the containment vessel, optionally after separating the containment vessel from the transport vessel, and optionally aimed. In step S86, the solar reflectance optionally is assessed to confirm the orbital position or atmospheric drift rate to better target future deployments of reflective hollow silicate glass microspheres for SRM.

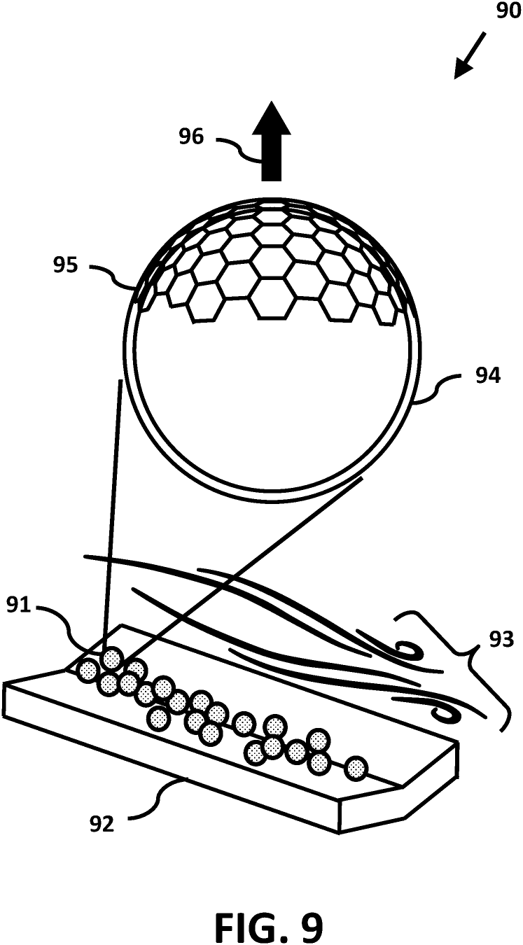

FIG. 9 serves to illustrate further embodiments of the invention in which the silicate microspheres 90 include a surface coating 95. Multiple reflective glass microspheres 90 are represented by shaded round circles of which one 91 is represented in an enlarged view. A deposited coating 95 is provided to cover at least about one third of the external surface 94 of microsphere 90. Deposited coating 95 can be applied by vapor deposition, represented here by vapors 93. In the illustration, a tray 92 retains the glass microspheres 90 during the deposition process. In some embodiments, a floating bed conveyor can be used in place of the tray 92. It is understood that other methods of coating deposition are possible, such as vacuum sputtering deposition, or fluid-based methods where the tray 92 is used to support a fluid medium to enable a chemical deposition from a liquid deposition matrix.

The resulting coated region 95 on the exterior surface of the glass microspheres 90 are preferably a dark color, such as is obtained by carbon black or graphite, and is added to absorb solar radiation, thereby producing a heated area that makes air in the vicinity rise to produce lift, where the lift force is indicated by the upward direction of the solid black the arrow 96. The production of lift on the glass microsphere during hours of solar illuminance serves to increase the microsphere lofted altitude as well as to increase the microsphere residence or lifetime. This process is termed “solar powered lofting” and saves considerably in the deployment altitude, since the microspheres will automatically migrate to higher altitudes. One suitable material for a solar powered lofting coating 95 is soot, or amorphous black carbon, that can be deposited at or near room temperature in a gas vapor. The coating 95 can also be a graphitic coating when the deposition temperature is about 550° C., and the deposit process is at a reduced pressure or less than about 12 torr.

Other types of coatings 95 can be substituted or added to any portion of the microspheres 90 by use of the deposition method, for instance, a stabilizing zinc indium sulfide (ZnIn₂S₄) catalyst. This material is already in ground-level commercial use for some types of CO₂ electroreduction to formic acid or sodium formate. This or a similar chemical process allows carbon sequestration to take place at the surface of the glass microsphere 90 when exposed to liquid water. The presence of highly charged cloud layers enables chemical reactivity as one way to perform gaseous carbon dioxide sequestration. The silicate glass microsphere 90 may optionally consist of a soda-glass or sodium containing silicate glass, where the alkali chemistry of the glass is able to react with gaseous CO₂, or water borne carbonic acid, to form sodium bicarbonate, which forms at the surface of the glass microsphere in contact with liquid water.

In addition, the particle sizes of at least six times greater than the presently known 14-micron average of particles found at altitude overcomes previous SRMs limited by high density and solid mass. The hollow microsphere SRM particle configuration significantly promotes greater reflectivity, and greater service life in the air, as compared to well-known simulation results obtained using high-density solid particle structures. Solar powered particle lift becomes greatly enabled using large hollow particles of low density, just as greater aircraft wing area acts to increase lift for conventional air powered transportation. Finally, solar powered lofting creates long atmospheric residence lifetimes that significantly reduce or eliminate the risk of deployment termination shock to the global climate, should the atmospheric placement or replacement SRM happen to stop for any unforeseeable reason. These specific examples are meant to be representative but non-limiting methods of coating hollow glass microspheres for solar radiation management, carbon sequestration by fixing or reacting with CO₂, or both sequestration and SRM with optional solar powered lofting. Any of these methods of coating are part of the reduced density and SRM objectives when used in accordance with the intent of the present invention.

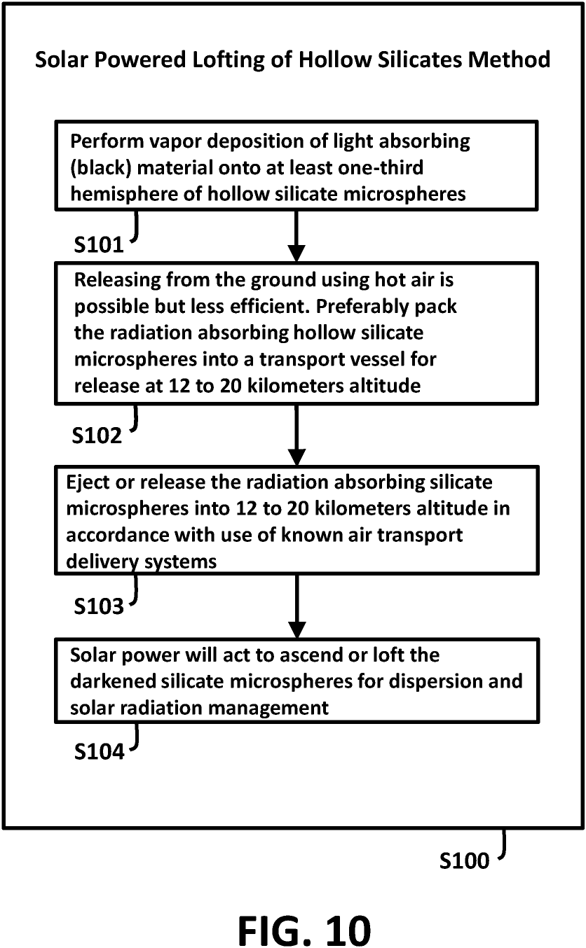

FIG. 10 is a flowchart representation of an exemplary method S100 of solar radiation management by solar-lofted hollow silicate microspheres. In step S101, vapor deposition of a light absorbing material is performed onto at least one-third of the hollow silicate microspheres. The coating is preferably dark or black as deposited. The function of the dark coating is to provide lift when heated by the sun. This creates hot air in the vicinity of the coated glass microsphere. Because hot air rises upward, the glass microsphere is carried in an upward direction. This function is hereinafter called solar-powered lofting. One or more other coatings may also be applied to at least one-third of the hollow silicate microspheres, depending on the desired SRM, solar powered lofting, and / or CO₂ sequestration function in any combination.

In step S102, the SRM release method is determined. In some embodiments the most economic method or the desired rate of release method is selected. For example, one way to avoid air transport costs is to release the self-lofting hollow silicate microspheres from the ground is by means of a hot air discharge such as from an upward directed air flow from a smokestack, cooling tower, or chimney. The self-lofting microspheres can also be delivered at 12 to 20 kilometers altitude by aircraft (e.g., drones, balloons, airplanes, etc.) where they can use solar powered lofting to rise to 80 kilometers in altitude for extended periods of time. Alternatively, and especially in Earth orbit, a rocket can be used for microsphere SRM release, as described above.

In step S103, the self-lofting silicate microspheres are released at an altitude of about 12 to about 20 kilometers. The methods described above for release from containment vessels, including the use of a dispersant and the use of electrostatic charging of the microspheres, apply equally to embodiments employing coated microspheres. It is noted that electrostatic charging can be useful to attract moisture to initiate rainfall. It is furthermore noted that electrostatic charging provided by wind friction or solar charged particles is useful to activate electrocatalysis and chemical conversion of carbon dioxide into substances that precipitate from the atmosphere.

In step S104 solar radiation heats the darkened regions of the hollow glass microspheres to enable the self-lofting function so that the microspheres will ascend to at least 50 kilometers to perform solar radiation management, while being able to persist at such altitude because of their low density.

It is understood that the orbital placement or the atmospherically lofted reflective hollow borosilicate glass microspheres deployed in accordance with this method, have a finite and decaying lifetime, as well as a useful but limited product duty period. Once the orbital or elevated service period has reached its limit, the individual microspheres will fall to lower levels, and finally descend to the planet to become disposed at the surface. At this point, the materials of the silicate microspheres are returned to both land surfaces and ocean surfaces, where they will temporarily continue to reflect solar radiation before becoming covered by less reflective materials or dissolving and then sinking to the ocean depths as their closed hollow interiors become open to fill with seawater.

As variations, combinations and modifications may be made in the construction and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments but defined in accordance with the foregoing claims appended hereto and their equivalents.

What is claimed is:

1. A method of geoengineering comprising:
providing a rocket or aircraft with at least one containment vessel including a plurality of hollow silicate glass microspheres sized greater than 10 microns and less than about 100 microns in diameter and having a specific reflectivity greater than about 3.5;
using the rocket or aircraft to deliver the containment vessel into a low Earth orbit, the orbit being from about 250 kilometers to about 2000 kilometers high, or using the rocket to deliver the containment vessel to a solar orbit between the sun and the Earth at the L1 point; and
releasing the plurality of hollow glass silicate microspheres into the solar or low Earth orbit from the containment vessel.

2. The method of claim 1 wherein the silicate glass microspheres comprise a sodium silicate glass.

3. The method of claim 2 wherein the sodium silicate glass comprises greater than 16 percent sodium by weight.

4. The method of claim 3 wherein the sodium silicate glass includes more than about 20% sodium.

5. The method of claim 1 wherein the hollow interiors of the silicate glass microspheres are filled with a gas at a pressure below about 1 atm.

6. The method of claim 1 wherein the containment vessel further includes a dispersant.

7. The method of claim 6 wherein the dispersant comprises a gas.

8. The method of claim 6 wherein the dispersant comprises a fuel.

9. The method of claim 1 wherein releasing the plurality of hollow silicate glass microspheres into the solar or low Earth orbit includes electrostatically charging the plurality of hollow silicate glass microspheres.

10. The method of claim 1 wherein the low Earth orbit is between 40 degrees north latitude and 40 degrees south latitude.

11. The method of claim 1 further comprising manufacturing the hollow glass silicate microspheres comprising silicate minerals mined on the Moon or an asteroid.

12. A method of geoengineering comprising:
providing an aircraft or rocket with at least one containment vessel including a plurality of hollow silicate glass microspheres sized greater than about 10 microns and less than about 100 microns in diameter and having a specific reflectivity greater than about 3.5;
using the aircraft or rocket to deliver the containment vessel into the atmosphere; and
releasing the plurality of hollow silicate glass microspheres into the atmosphere from the containment vessel.

13. The method of claim 12 wherein the silicate glass microspheres comprise a sodium silicate glass.

14. The method of claim 13 wherein releasing the plurality of hollow sodium silicate glass microspheres into the atmosphere is performed at an altitude ranging from about 10 kilometers to about 50 kilometers.

15. The method of claim 13 wherein the sodium silicate glass microspheres comprise at least 20% sodium.

16. The method of claim 15 wherein releasing the plurality of hollow silicate glass microspheres into the atmosphere is performed at an altitude ranging from about 100 meters to about 10,000 meters.

17. The method of claim 12 wherein the hollow interiors of the silicate glass microspheres are filled with a gas at a pressure below about 1 atm.

18. The method of claim 12 wherein the containment vessel further includes a dispersant.

19. The method of claim 18 wherein the dispersant comprises a gas.

20. The method of claim 18 wherein the dispersant comprises a fuel.

21. The method of claim 12 wherein releasing the plurality of hollow silicate glass microspheres into the atmosphere includes electrostatically charging the plurality of hollow silicate glass microspheres.

22. The method of claim 12 wherein releasing the plurality of hollow silicate glass microspheres into the atmosphere is performed between 40 degrees north latitude and 40 degrees south latitude.

23. The method of claim 12 wherein releasing the plurality of hollow silicate glass microspheres into the atmosphere includes releasing the plurality of hollow glass microspheres over a predicted tropical storm pathway.

24. A method of cloud seeding comprising:
lofting a plurality of hollow glass microspheres sized greater than about 10 microns and less than about 100 microns in diameter and having a specific reflectivity greater than about 3.5; by
mixing the plurality of hollow glass microspheres with a heated gas, and
releasing the heated gas including the hollow glass microspheres into the atmosphere, wherein the air of the atmosphere is cooler that the heated gas.

25. The method of claim 24 wherein the heated gas including the hollow glass microspheres is released through a chimney or cooling tower.

26. The method of claim 24 wherein the silicate glass microspheres comprise a silicate glass including at least 20% sodium.
